(19) United States
(12) Patent Application Publication
(10) Pub. No.: US 2020/0131916 A1
(43) Pub. Date: Apr. 30, 2020

(54) TURBINE BLADE ASSEMBLY

(71) Applicant: United Technologies Corporation, Farmington, CT (US)

(72) Inventors: Jonathan Jeffery Eastwood, West Hartford, CT (US); Russell J. Bergman, South Windsor, CT (US); Joseph T. Caprario, Rocky Hill, CT (US); Scott D. Virkler, Ellington, CT (US)

(21) Appl. No.: 16/177,331

(22) Filed: Oct. 31, 2018

(51) Int. Cl. F01D 5/30; F01D 5/32

(52) U.S. Cl. CPC F01D 5/3007; F05D 2260/30; F01D 5/323

(57) ABSTRACT

A turbine blade assembly for a gas turbine engine is provided. The turbine blade assembly having: a rotor; a plurality of turbine blades mounted to the rotor, each of the plurality of turbine blades having a forward tab that contacts a front face of the rotor and an aft tab; a plurality of tabs that extend from an aft surface of the rotor; and a retaining ring that engages each aft tab of the plurality of turbine blades and each of the plurality of tabs that extend from the aft surface of the rotor.

### STATEMENT OF FEDERAL SUPPORT

This invention was made with Government support under W911W6-16-2-0012 awarded by the United States Army. The Government has certain rights in this invention.

### BACKGROUND

Embodiments of the present disclosure pertain to turbine blade assemblies and apparatus and methods from holding turbine blades in place.

Typically turbine blades in gas turbine engines are held in place on the perspective rotor by a slotted arrangement. This type of arrangement can be used in applications where the turbine blade is separate from the rotor. In other words, the turbine blade is separately installed to the rotor as opposed to an integrally formed rotor assembly. This slot arrangement holds the blade in place radially and allows for the removal of the blade by sliding it (e.g., axially) into and out of the groove in the rotor.

Accordingly, it is desirable to provide an improved turbine blade assembly which secures the turbine blade to the rotor.

### BRIEF DESCRIPTION

Disclosed is a turbine blade assembly for a gas turbine engine, the turbine blade assembly including: a rotor; a plurality of turbine blades mounted to the rotor, each of the plurality of turbine blades having a forward tab that extends radially downward from the turbine blade and contacts a front face of the rotor when a root portion of the turbine blade is slid into a complementary slot of the rotor, wherein each of the plurality of turbine blades has an aft tab that extends from the root portion to define a gap between an aft surface of the root portion and the aft tab; a plurality of tabs that extend from an aft surface of the rotor; and a retaining ring that engages each aft tab of plurality of turbine blades and each of the plurality of tabs that extend from the aft surface of the rotor, wherein an upper peripheral edge of the retaining ring contacts a surface of the plurality of tabs that extend from the aft surface of the rotor when the retaining ring is inserted between the aft tab of the plurality of turbine blades, and wherein the upper peripheral edge of the retaining ring does not contact an inner diameter surface of the plurality of tabs that is located radially above the retaining ring when the retaining ring is inserted between the aft tab of the plurality of turbine blades.

In addition to one or more of the features described above, or as an alternative to any of the foregoing embodiments, the plurality of tabs are integrally formed with the rotor.

In addition to one or more of the features described above, or as an alternative to any of the foregoing embodiments, the retaining ring further comprises an anti-rotation feature that is located between a pair of aft tabs of adjacent turbine blades secured to the rotor.

In addition to one or more of the features described above, or as an alternative to any of the foregoing embodiments, the anti-rotation feature protrudes from an aft surface of the retaining ring.

In addition to one or more of the features described above, or as an alternative to any of the foregoing embodiments, the retaining ring is provided with a split.

In addition to one or more of the features described above, or as an alternative to any of the foregoing embodiments, the split is located radially below one of plurality of tabs that extends from the aft surface of the rotor.

In addition to one or more of the features described above, or as an alternative to any of the foregoing embodiments, the retaining ring is provided with a split.

In addition to one or more of the features described above, or as an alternative to any of the foregoing embodiments, the split is located radially below one of plurality of tabs that extends from the aft surface of the rotor.

In addition to one or more of the features described above, or as an alternative to any of the foregoing embodiments, the outside diameter of the plurality of turbine blades when secured to the rotor is up to 15.5 inches.

In addition to one or more of the features described above, or as an alternative to any of the foregoing embodiments, the outside diameter of the rotor is up to 11 inches.

Also disclosed is a gas turbine engine. The gas turbine engine having at least one blade assembly, the at least one blade assembly comprising: a rotor; a plurality of turbine blades mounted to the rotor, each of the plurality of turbine blades having a forward tab that extends radially downward from the turbine blade and contacts a front face of the rotor when a root portion of the turbine blade is slid into a complementary slot of the rotor, wherein each of the plurality of turbine blades has an aft tab that extends from the root portion to define a gap between an aft surface of the root portion and the aft tab; a plurality of tabs that extend from an aft surface of the rotor; and a retaining ring that engages each aft tab of plurality of turbine blades and each of the plurality of tabs that extend from the aft surface of the rotor, wherein an upper peripheral edge of the retaining ring contacts a surface of the plurality of tabs that extend from the aft surface of the rotor when the retaining ring is inserted between the aft tab of the plurality of turbine blades, and wherein the upper peripheral edge of the retaining ring does not contact an inner diameter surface of the plurality of tabs that is located radially above the retaining ring when the retaining ring is inserted between the aft tab of the plurality of turbine blades.

In addition to one or more of the features described above, or as an alternative to any of the foregoing embodiments, the plurality of tabs are integrally formed with the rotor.

In addition to one or more of the features described above, or as an alternative to any of the foregoing embodiments, the retaining ring further comprises an anti-rotation feature that is located between a pair of aft tabs of adjacent turbine blades secured to the rotor.

In addition to one or more of the features described above, or as an alternative to any of the foregoing embodiments, the anti-rotation feature protrudes from an aft surface of the retaining ring.

In addition to one or more of the features described above, or as an alternative to any of the foregoing embodiments, the retaining ring is provided with a split and wherein the split is located radially below one of plurality of tabs that extends from the aft surface of the rotor.

In addition to one or more of the features described above, or as an alternative to any of the foregoing embodiments, a distal end of the forward tab extends radially past the root portion of the turbine blade it is secured to.

In addition to one or more of the features described above, or as an alternative to any of the foregoing embodiments, the aft tab extends axially from the aft surface of the root portion to define the gap.

Also disclosed is a method of securing a turbine blade to a rotor of a gas turbine engine. The method including the steps of: sliding a root portion of a plurality of turbine blades into a corresponding slot of the rotor, each of the plurality of turbine blades having a forward tab that extends radially downward from the turbine blade and an aft tab that extends from the root portion to define a gap between a surface of the root portion and the aft tab; contacting a front face of the rotor with the forward tab; engaging a plurality of tabs that extend from an aft surface of the rotor and the aft tab of the plurality of turbine blades with a retaining ring, wherein an upper peripheral edge of the retaining ring contacts a surface of the plurality of tabs that extend from the aft surface of the rotor when the retaining ring is inserted between the aft tab of the plurality of turbine blades, and wherein the upper peripheral edge of the retaining ring does not contact an inner diameter surface of the plurality of tabs that is located radially above the retaining ring when the retaining ring is inserted between the aft tab of the plurality of turbine blades.

In addition to one or more of the features described above, or as an alternative to any of the foregoing embodiments, a step of locating an anti-rotation feature between a pair of aft tabs of adjacent turbine blades secured to the rotor is provided.

### BRIEF DESCRIPTION OF THE DRAWINGS

The following descriptions should not be considered limiting in any way. With reference to the accompanying drawings, like elements are numbered alike:

FIG. 1 is a cross-sectional view of a gas turbine engine;

FIG. 2 is a cross-sectional view of a portion of a turbine section of the gas turbine engine illustrated in FIG. 1;

FIG. 3 is a perspective view illustrating a turbine blade being slid into the a rotor in accordance with the present disclosure;

FIG. 4 is a perspective view illustrating a turbine blade slid into the rotor of FIG. 3;

FIG. 5 is a cross-sectional view illustrating a turbine blade secured to the rotor with a retaining ring;

FIG. 6 is a forward perspective view illustrating a turbine blade secured to the rotor;

FIG. 7 is a rear perspective view illustrating a turbine blade secured to the rotor with a retaining ring;

FIG. 8A is a partial cross-sectional view of a turbine rotor in accordance with the present disclosure;

FIG. 8B is a rear perspective view of the rotor of FIG. 8A;

FIG. 9A is a partial rear view of the rotor with a plurality of turbine blades secured thereto with a blade retaining ring; and

FIG. 9B is a partial rear view of the rotor of FIG. 9A without the plurality of turbine blades secured thereto.

### DETAILED DESCRIPTION

A detailed description of one or more embodiments of the disclosed apparatus and method are presented herein by way of exemplification and not limitation with reference to the Figures.

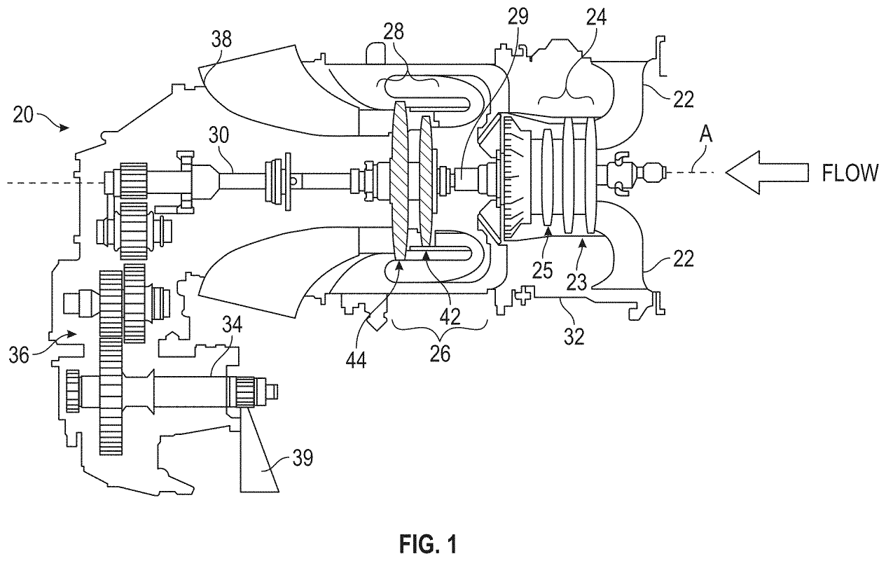

FIG. 1 schematically illustrates a gas turbine engine 20. In the illustrated embodiment, the engine 20 is a turboshaft engine, which may be used in a helicopter or any other type of aircraft. The engine 20 includes an inlet duct 22, a compressor section 24, a combustor section 26, and a turbine section 28. The compressor section 24 is an axial compressor and includes a plurality of circumferentially-spaced blades. Similarly, the turbine section 28 includes circumferentially-spaced turbine blades. The compressor section 24 and the turbine section 28 are mounted on a main shaft 29 for rotation about an engine central longitudinal axis A relative to an engine static structure 32 via several bearing systems (not shown).

During operation, the compressor section 24 draws air through the inlet duct 22. In this example, the inlet duct 22 opens radially relative to the central longitudinal axis A. The compressor section 24 compresses the air, and the compressed air is then mixed with fuel and burned in the combustor section 26 to form a high pressure, hot gas stream. The hot gas stream is expanded in the turbine section 28, which may include first and second turbine 42, 44.

The first turbine 42 rotationally drives the compressor section 24 via a main shaft 29. Together these components provide a gas generator portion of the engine 20. The second turbine 44, which is a power turbine in the example embodiment, is located aft or downstream of the first turbine 42 and rotationally drives a power shaft 30, gearbox 36, and output shaft 34. Although fluidly coupled to the gas generator portion, the power turbine 44 is mechanically disconnected from the gas generator portion. That is, the main shaft 29 and power shaft 30 are not connected to one another, such that the shafts 29, 30 rotate separately and at different speeds. Moreover, there are no compressors mounted to the power shaft 30. The power turbine 44 can be made up of a single or multiple stages of blades and vanes. The output shaft 34 rotationally drives the helicopter rotor blades 39 used to generate lift for the helicopter. The hot gas stream is expelled through an exhaust 38.

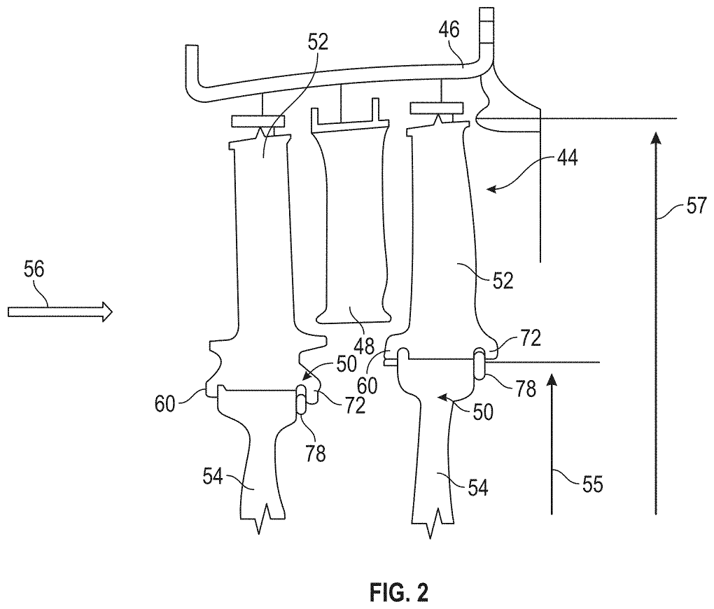

The power turbine 44 is shown in more detail in FIG. 2. In one non limiting embodiment, the power turbine 44 and its associated turbine assemblies 50 may operate at up to 25,000 RPMs or in another embodiment within a range of 25,300 to 13,900 RPM. Of course, the power turbine 44 may operate in ranges greater or less than the aforementioned range as well as RPMs greater than 25,300 or less than 13,900.

The power turbine 44 includes stages of stator vanes 48 axially spaced apart from one another and supported with respect to the turbine case structure 46, which is part of the engine static structure 32. Stages of turbine blade assemblies 50 are axially interspersed between the stages of stator vanes 48. Each of the turbine blade assemblies 50 have a plurality of turbine blades 52 mounted to a rotor 54. In the illustrated embodiment of FIG. 2, two aft turbine blade assemblies 50 are shown as one example. Of course, the number of turbine blade assemblies 50 may vary and may be greater or less than two. Air flows into the power turbine 44 in the direction of arrow 56. Thus and referring to at least FIG. 2 air is flowing in a fore to aft direction or the turbine blade assembly 50 furthest to the right in FIG. 2 is the aft turbine blade assembly of power turbine 44. As used herein, fore and aft or forward and rearward or upstream and downstream refer to the flow of air into the turbine or are positional locations with respect to arrow 56.

In one non-limiting embodiment, the turbine blade assemblies 50 may be referred to as small diameter assemblies wherein the outer diameter of the aft most rotor 54 is approximately 10.0 inches and the outer diameter to the tip of the turbine blade 52 of the aft most turbine blade assembly 50 is approximately 15.5 inches. It being understood that in one embodiment, the aft most turbine blade assembly 50 is greater than the preceding or forward blade assemblies. Of course, other configurations contemplate embodiments wherein the aft most turbine blade assembly 50 is the same size or smaller than the preceding or forward blade assemblies. The outer diameter of the aft most rotor 54 is illustrated at least partially with arrow 55 in FIG. 2 and the outer diameter to the tip of the turbine blade 52 of the aft most turbine blade assembly 50 is illustrated at least partially with arrow 57 in FIG. 2. These diameters are centered about axis A when the blade assembly 50 is secured to the engine 20. Of course, diameters greater or less than the aforementioned values are contemplated to be within the scope of the present disclosure.

In view of these “small diameter” blade assemblies 50, the aforementioned operational ranges of 25,300 to 13,900 RPM can be achieved. Moreover, high centripetal or radially outward forces are also experienced by the turbine assemblies 50 when the engine 20 is in operation.

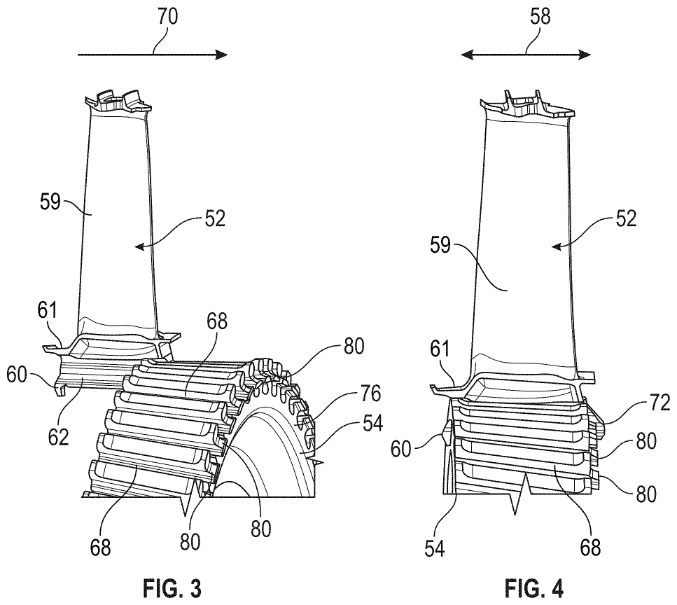

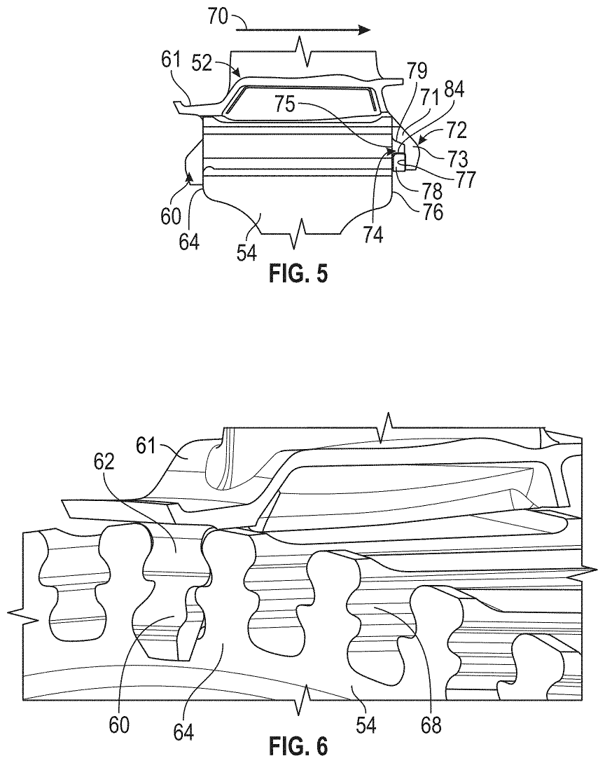

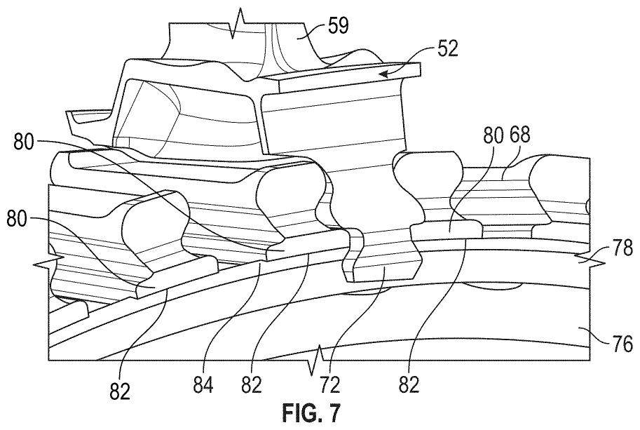

Referring now to at least FIGS. 2-9B, the turbine blade 52 has an airfoil portion 59 extending radially upward from a platform 61 located between the airfoil 59 and a root 62 of the turbine blade 52. In order to hold the turbine blade 52 in place in the axial direction (arrows 58) with respect to the rotor 54, a first or a forward vertical tab or stop 60 extends radially downward from the turbine blade 52. As used herein, radially refers to axis A such that radially downward means towards axis A while radially upward means away from axis A. The forward tab 60 is located at a forward end of the turbine blade 52 and extends radially past a root 62 of the blade 52 such that the first or forward tab of vertical tab or stop 60 sits against a surface or front face 64 of the rotor 54 when the root portion 62 of the turbine blade 52 is slid into a complementary slot 68 of the rotor 54.

As the turbine blade 52 is inserted into slot 68 in the direction of arrow 70, the forward tab 60 contacts surface 64 and sets the correct axial location of the turbine blade 52 in rotor 54. This will provide the primary axial retention during operation as the aero loads on the blades push the blade aft in the direction of arrow 70. When the turbine blades 52 are installed, they slide into the slots 68 in the rotor 54 until the forward tab 60 sits against the rotor face 64.

In addition, a second or aft tab 72 is used to hold the blade 52 in place and prevent movement in a direction opposite to arrow 70 once the blade is secured to the rotor 54. The second tab or aft tab 72 comprises a connecting portion 71 and a retention portion 73. The connecting portion 71 extends axially from an aft end 75 of the root 62 and the retention portion 73 extends from the connecting portion 71. The retention portion 73 extends radially downward from connecting portion 71 as well as the turbine blade 52. As such, the retention portion 73 is spaced axially from the aft end of the root 62 such that a gap or space 74 is present between a contact surface 77 of the retention portion 73 of the aft tab 72 and an aft end 75 of the root 62.

Thus and when the forward tab 60 is in contact with surface 64 the gap or space 74 is located axially past an aft end or aft surface 76 of the rotor 54. This will allow a retaining ring 78 to be inserted into gap or space 74 such that the retaining ring 78 can be disposed between the aft end 75 of the root 62 and the retention portion 73 of aft tab 72. In addition, the retaining ring 78 will also contact the aft surface 76 of the rotor 54 such that when the retaining ring 78 is disposed between the aft end 75 of the root 62 and the retention portion of aft tab 72 it will contact the contact surface 77 of the retention portion 73 of the aft tab 72 on one side and the aft surface 76 of the rotor 54 on an opposite side such that the blade 52 cannot be moved in a direction opposite to arrow 70 once the retaining ring 78 is disposed between the aft end 75 of the root 62 and the retention portion of aft tab 72 when the forward tab 60 sits against or contacts the rotor face 64.

The connecting portion 71 and the retention portion 73 of the aft tab 72 are integrally formed with the turbine blade 52. As used herein, integrally formed means that the connecting portion 71 and the retention portion 73 of the aft tab 72 are formed as a single piece with the turbine blade 52 proximate to the root 62 such that the connecting portion 71 and the retention portion 73 of the aft tab 72 cannot be removed from the turbine blade 52 unless some form of cutting process is used. More particularly, formed as a single piece may be referred to as casting, additive manufacturing or any other suitable process wherein the turbine blade 52 is formed as a single piece with at least the aft tab 72 and the forward tab 60 integrally formed therewith.

The connecting portion 71 of the aft tab 72 has an inner surface 79 that extends at least axially from the aft end 75 of the root 62 to the contact surface 77 of the retention portion 73. Inner surface 79 extends above gap or space 74 and is not contacted by retaining ring 78 when it is located between the aft end 75 of the root 62 and the retention portion 73 of aft tab 72. This will be discussed in further detail below.

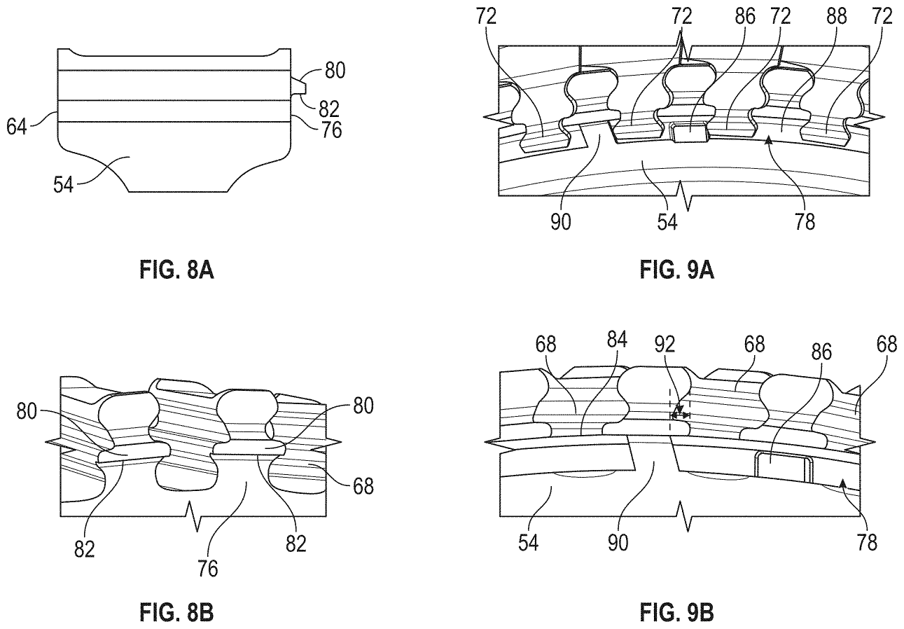

In addition, the aft surface 76 of the rotor 54 has a plurality of integrally formed aft tabs 80 (see at least FIGS. 8A-9B) that extend axially from the aft surface 76 of the rotor. The aft tabs 80 and provide a radial stop for the retaining ring 78 such that when the retaining ring 78 is inserted in between tabs 72 and surface 76 as well as the aft end 75 of the root 62, the retaining ring 78 will not contact inner surface 79 of the connecting portion 71 of the aft tab 72 that extends at least partially in an axially direction between the aft end 75 of the root 62 and the contact surface 77 of the retention portion of the aft tab 72. This maintains a gap between an upper peripheral edge 84 of the retaining ring 78 and the inner surface 79 of the connecting portion 71 of the aft tab 72. This is due to the fact that the upper peripheral edge 84 of the retaining ring 78 will first contact an inner diameter or surface 82 of the aft tabs 80 prior to it contacting the inner surface 79 of the connecting portion 71 of the aft tab 72. The inner diameter or surface 82 of the aft tabs 80 extends in an axial direction from the surface 76 of the rotor 54. In other words, the aft tabs 80 and retaining ring 78 are configured to have the retaining ring 78 contact the aft tabs 80 prior to it contacting the inner surface 79 of the connecting portion 71 of the aft tab 720. This contact with tabs 80 of the rotor 54 and lack of contact with inner surface 79 of the connecting portion 71 of the aft tab 72 will prevent radial loads of the retaining ring 78 from being applied to the turbine blade 52 in a direction away from axis A. This is particularly useful when the turbine assemblies 50 are rotating in the aforementioned ranges of 13,900 to 25,300 RPMs.

In addition and as illustrated in at least FIGS. 9A and 9B, the retaining ring 78 is provided with an anti-rotation feature, protrusion or tab 86 that protrudes from an aft surface 88 of the retaining ring 78. This anti-rotation feature, protrusion or tab 86 is configured to be located between a pair of tabs 72 of adjacent turbine blades 52 such that rotation of the retaining ring 78 about axis A will be prevented by contact with one of tabs 72. In addition, retaining ring 78 is provided with a split or gap 90 that allows for deflection of retaining ring 78 in order to install the same to the rotor assembly 50.

Also shown in at least FIG. 9B, which illustrates the rotor assembly 50 without the turbine blades 52, is that with protrusion 86 there will always be an overlap 92 with the ends of retaining ring 78 and tab 80 proximate to split or gap 90 of the retaining ring 78 due to the fact that protrusion 86 will contact one of the tabs 72 and provide a rotational limit of the retaining ring 78 about axis A.

In the disclosed power turbine blade assembly 50, the blade/rotor arrangement uses a tab 60 on the front of the turbine blade 52 to provide an axial stop between the forward face 64 of the rotor 54 combined with a retaining ring 78 at an aft section of the turbine blade 52. The retaining ring 78 is positioned on the aft surface 76 of the rotor 54 and engages into the groove or gap 74 between the second or aft tab 72 and the aft surface 75 of the root 62 of the blade 52. The ring 78 provides an axial retention feature which prevents the blade 52 from moving forward in the engine during assembly while the engine is not running. The aero loads on the blade 52 push it in the aft direction during operation, that load will be reacted to the rotor 54 by the blade's forward tab 60. However, there can also be a small load in the opposite direction which will push the blade 52 forward, that load would be taken by the ring 78.

The ring's 78 radial height and axial thickness and is sized appropriately to handle this load along with the associated radial loads from a snap ring of this kind. Radially the retaining ring 78 does not contact the inner surface 79 of the connecting portion 71 of the aft tab 72, as it will come into contact with inner diameter or surface 82 of the tabs 80 on the rotor 54 prior to it reaching the inner surface 79 of the connecting portion 71 of the aft tab 72.

During assembly, the turbine blades 52 are installed into the rotor slots 68 one by one from the front until they bottom out on the forward tab 60. The retaining ring 78 features a split 90 in the ring along with an anti-rotation tab 86 just adjacent to it. When the ring is installed, the anti-rotation tab 86 is installed in between any one of the individual aft blade tabs 72. The purpose of the anti-rotation tab 86 on the ring 78 is to keep the ring 78 from spinning during operation along with aligning the open segment 90 of the ring under one of the circumferential tabs 80 on the rotor 54. The location of the anti-rotation tab will be dimensioned from the slot 90 in the ring 78 in order to ensure that the edges of the retaining ring 78 does not fall off of the tab 80 during and acceleration or deceleration of the engine 20 where the parts would be at different temperatures.

The retaining ring 78 is being used in this application as there is no coverplate, minidisk or other features that would hold the blade in place axially. The retaining ring used in this application is much lighter and simpler than adding one of the above mentioned features. Thus, the retaining ring 78 is desired for the disclosed turbine blade assembly 50.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A turbine blade assembly for a gas turbine engine, comprising:
a rotor;
a plurality of turbine blades mounted to the rotor, each of the plurality of turbine blades having a forward tab that extends radially downward from the turbine blade and contacts a front face of the rotor when a root portion of the turbine blade is slid into a complementary slot of the rotor, wherein each of the plurality of turbine blades has an aft tab that extends from the root portion to define a gap between an aft surface of the root portion and the aft tab;
a plurality of tabs that extend from an aft surface of the rotor; and
a retaining ring that engages each aft tab of the plurality of turbine blades and each of the plurality of tabs that extend from the aft surface of the rotor, wherein an upper peripheral edge of the retaining ring contacts a surface of the plurality of tabs that extend from the aft surface of the rotor when the retaining ring is inserted between the aft tab of the plurality of turbine blades and the rotor, and wherein the upper peripheral edge of the retaining ring does not contact an inner diameter surface of the plurality of aft tabs that are located radially above the retaining ring when the retaining ring is inserted between the aft tabs of the plurality of turbine blades and the rotor.

2. The turbine blade assembly as in claim 1, wherein the plurality of tabs are integrally formed with the rotor.

3. The turbine blade assembly as in claim 1, wherein the retaining ring further comprises an anti-rotation feature that is located between a pair of aft tabs of adjacent turbine blades secured to the rotor.

4. The turbine blade assembly as in claim 3, wherein the anti-rotation feature protrudes from an aft surface of the retaining ring.

5. The turbine blade assembly as in claim 4, wherein the retaining ring is provided with a split.

6. The turbine blade assembly as in claim 5, wherein the split is located radially below one of plurality of tabs that extends from the aft surface of the rotor.

7. The turbine blade assembly as in claim 1, wherein the retaining ring is provided with a split.

8. The turbine blade assembly as in claim 7, wherein the split is located radially below one of plurality of tabs that extends from the aft surface of the rotor.

9. The turbine blade assembly as in claim 1, wherein the outside diameter of the plurality of turbine blades when secured to the rotor is up to 15.5 inches.

10. The turbine blade assembly as in claim 1, wherein the outside diameter of the rotor is up to 11 inches.

11. A gas turbine engine having at least one blade assembly, the at least one blade assembly comprising:
a rotor;
a plurality of turbine blades mounted to the rotor, each of the plurality of turbine blades having a forward tab that extends radially downward from the turbine blade and contacts a front face of the rotor when a root portion of the turbine blade is slid into a complementary slot of the rotor, wherein each of the plurality of turbine blades has an aft tab that extends from the root portion to define a gap between an aft surface of the root portion and the aft tab;
a plurality of tabs that extend from an aft surface of the rotor; and
a retaining ring that engages each aft tab of the plurality of turbine blades and each of the plurality of tabs that extend from the aft surface of the rotor, wherein an upper peripheral edge of the retaining ring contacts a surface of the plurality of tabs that extend from the aft surface of the rotor when the retaining ring is inserted between the aft tab of the plurality of turbine blades and the rotor, and wherein the upper peripheral edge of the retaining ring does not contact an inner diameter surface of the plurality of aft tabs that are located radially above the retaining ring when the retaining ring is inserted between the aft tab of the plurality of turbine blades and the rotor.

12. The gas turbine engine as in claim 11, wherein the plurality of tabs are integrally formed with the rotor.

13. The gas turbine engine as in claim 11, wherein the retaining ring further comprises an anti-rotation feature that is located between a pair of aft tabs of adjacent turbine blades secured to the rotor.

14. The gas turbine engine as in claim 13, wherein the anti-rotation feature protrudes from an aft surface of the retaining ring.

15. The gas turbine engine as in claim 14, wherein the retaining ring is provided with a split and wherein the split is located radially below one of plurality of tabs that extends from the aft surface of the rotor.

16. The gas turbine engine as in claim 11, wherein a distal end of the forward tab extends radially past the root portion of the turbine blade it is secured to.

17. The gas turbine engine as in claim 16, wherein the aft tab extends axially from the aft surface of the root portion to define the gap.

18. The gas turbine engine as in claim 11, wherein the aft tab extends axially from the aft surface of the root portion to define the gap.

19. A method of securing a turbine blade to a rotor of a gas turbine engine, comprising:
sliding a root portion of a plurality of turbine blades into a corresponding slot of the rotor, each of the plurality of turbine blades having a forward tab that extends radially downward from the turbine blade and an aft tab that extends from the root portion to define a gap between a surface of the root portion and the aft tab;
contacting a front face of the rotor with the forward tab;
engaging a plurality of tabs that extend from an aft surface of the rotor and the aft tab of the plurality of turbine blades with a retaining ring, wherein an upper peripheral edge of the retaining ring contacts a surface of the plurality of tabs that extend from the aft surface of the rotor when the retaining ring is inserted between the aft tab of the plurality of turbine blades and the rotor, and wherein the upper peripheral edge of the retaining ring does not contact an inner diameter surface of the plurality of aft tabs that are located radially above the retaining ring when the retaining ring is inserted between the aft tab of the plurality of turbine blades and the rotor.

20. The method as in claim 19, further comprising locating an anti-rotation feature between a pair of aft tabs of adjacent turbine blades secured to the rotor.
